(19) United States
(12) Patent Application Publication
(10) Pub. No.: US 2022/0323873 A1
(43) Pub. Date: Oct. 13, 2022

(54) PORTABLE ARCADE UNIT

(71) Applicants: Maurice Berry, Chicago, IL (US); Jermaine Gause, Chicago, IL (US)

(72) Inventors: Maurice Berry, Chicago, IL (US); Jermaine Gause, Chicago, IL (US)

(21) Appl. No.: 17/008,504

(22) Filed: Aug. 31, 2020

Related U.S. Application Data
(60) Provisional application No. 62/894,768, filed on Aug. 31, 2019.

(51) Int. Cl. A63F 13/90

(52) U.S. Cl. CPC A63F 13/90

(57) ABSTRACT

A modular unit for portable arcade gaming with a lower profile than the standard arcade game cabinet or unit found in a game room or arcade with telescoping and foldable modular features for more comfort and convenience when transporting the unit for gaming at home or away. The unit houses several modules including a movable display module, a movable game controller tray, multiple removable game control modules with arcade-quality joysticks and buttons. The unit has doors to secure any gaming console(s). The modular unit expands in multiple ways to a full arcade unit for single or multiple players. The unit folds completely down into a compact portable unit easy for travel and storage. The unit can be comprised of a multitude of materials including plastic or wood. One of the preferred embodiments of the portable unit consists of several structural support panels, a door or doors opening outward exposing the inside of the cabinet for storage of any brand of game console. The unit further consists of a reliance panel, game controller tray, controller modules and retractable or foldable display modules and several locking and securing mechanisms for storage mode, transporting mode and interactive playing mode.

### CROSS REFERENCE TO RELATED APPLICATIONS

This non-provisional patent application claims priority to provisional patent U.S. 62/894,768 filed 31 Aug. 2019 pursuant to 35 USC § 119(e) the disclosure of which is incorporated herein by reference in its entirety.

### BACKGROUND OF INVENTION

### 1. Field of Invention

The at-home gaming experience includes simple game consoles connected to home television sets or displays for occasional gaming by single or multiple users. These units can accommodate multiple users through a variety of games and user interfaces. The gaming consoles are usually housed in the home furniture like the entertainment unit or multi-purpose cabinet for occasional gaming. The consoles are portable but the cabinets usually are not. The game consoles can be fully interactive for online play with other players no matter their location. Alternatively, the home gaming experience can also include full-sized arcade units usually found in gaming or recreational establishments. These units are large, expensive, highly difficult to port to other locations and also, usually, allow for zero interaction with other players online. The competitive gaming community is international and uses the internet to connect. While these full-sized arcade units are highly sought after by collectors and are expensive, present invention is built to suit the professional or competitive gamer and is a lot less expensive, smaller, portable and promotes interactive play.

As the levels of gaming have expanded, so have the needs of the gamer; the competitive gamer in specific. The competitive gamer is a professional requiring equipment to support the competitive gaming platform. The competitive gamer can “game” (play) from home or in a competitive environment like a tournament or high stakes competition away from home. This type of gaming can go on and on and last for hours. Comfort, portability, versatility, convenience and adaptability are needed to provide the professional competitive gamer the equipment support needed to allow for a superior performance whether at home or away. The game consoles, while portable, need other support like gaming cabinets, displays, chairs etc., and often time these items are not transportable. Present invention provides a unique solution to answer for the versatility needed to game in locations other than at home, comfortably. Gamers require comfort, portability, versatility, convenience and adaptability and present invention provides all of these features.

The present invention is a gaming cabinet providing comfort for the competitive and professional gamer via several features but most importantly the gaming control modules. These are not stationary or generic like existing controls on the market and are unique because they telescope to wherever the gamer is in relationship to the unit. The current state of the art provides small controllers for users which are not comparable to the full-sized arcade gaming unit which is one of the more comfortable pieces of equipment for professional and competitive gaming. The portable gaming cabinet has a gaming control module which simulates the full-sized arcade controls and, further, can be removed from the unit for a more comfortable gaming position.

The present invention is designed to offer portability in conjunction with comfort by being able to provide a full-sized arcade cabinet experience that is collapsible and can be transported anywhere the gamer requires by simply folding or retracting the cabinet's modular components to create a low-profile, fully mobile compact cabinet. Mobility can come from casters or any other movable additions affixed to the cabinet. The cabinet is also made with lightweight materials to be consistent with portability. Because the present invention can simulate the full-sized arcade experience while still supporting levels of comfort for the user from several positional options, it is a superior accompaniment for the gamer when traveling. The current “away from home” (away) options are small consoles with small controllers which would either have to be hooked into displays provided by the gaming venue or transported by the gamer himself. Securing the vast majority of displays for transport can be an issue for the traveling gamer. Displays are easily damaged in travel if not secured properly. Taking the time to properly secure the displays for travel id resolved by present invention. Additionally, the gaming equipment requires energy sources which can also be an issue for the traveling gamer. Present invention has a solution for reducing the need for several outlets; elevates the gamer's comfort and several issues associated with travel. The more the different issues can be addressed the easier it is for the gamer to travel.

The convenience factor of the present invention is in conjunction with its size, portability and adaptability. The gamer can use the present arcade unit like a full-sized gaming cabinet, or a gamer can use the portable feature of the cabinet and its modules to adapt the cabinet to different environments or gaming positions depending on the needs of the gamer at any given venue or time. The versatility of the gaming unit allows for its use in any environment and its adaptability makes it suitable for all types of gamers and venues. Its small footprint allows for it to be set in spaces where the traditional arcade cabinet would be too large and too rigid to adapt to but still providing the full arcade cabinet experience.

Arcade games are fairly expensive. The full-sized units range in price, beginning from anywhere around $2,500 and go up from there. They do include, however, both the hardware and software required for gaming. The present invention is only a cabinet unit. It is however a highly functional cabinet surpassing the utility of a full-sized arcade machine. The expense, versatility, portability and interactivity of the present invention is superior for the competitive or professional gamer and is the best accessory to the home gaming system. There is nothing else like present invention in the home gaming or competitive gaming market. The portable arcade unit is less expensive even with the addition of the gaming software and provides the arcade experience for the gamer at a much lower price.

This invention is a superior solution for the traveling gamer and gamers who would like a more comfortable yet interactive experience of a full-sized arcade game platform without the permanence (size and cost) of the full-sized arcade game. Professional and competitive gamers tend to spend hours upon hours at a time gaming. Ideally, the full-sized arcade machines are the best option for prolonged gaming as they are originally designed to support performance by the gamer-user at the professional competitive level. Purchasing, owning, transporting and storing a full-sized arcade game is prohibitive in a lot of ways. Aside from the hours spent gaming, professional and competitive gamers travel to different areas to compete and game, and full-sized arcade units are rarely interactive to the level needed by today's gamer. Current gaming consoles can be a solution to the size issues gamers face when housing gaming units in the home and they also allow easy portability in competitive and professional gaming, however, porting the gaming console is not the only issue gamers face. The setup is also an issue. The furniture or housing that accompanies the gaming console must also travel with the gamer or be available at the different venues causing quite an expense on the venue and competition hosts or for the gamers themselves. The hardware required to properly accommodate hundreds or thousands of gamers can be expensive and spatially difficult.

Other difficulties can arise in logistics, access to power sources, layout of the venue, the differences in equipment accommodations, and the list can go on. The present invention aims to answer these issues for the at-home gamer, the competitive gamer and for gaming events. Because professional and competitive gamers spend so much time gaming, creating a superior complement for their endeavors is key in present invention. Effectively supporting gamers' travel to tournaments and competitions also motivated present invention. Additionally, the size of a full-sized arcade game being so voluminous and taking up so much space further inspired the improvement that is present invention. Present invention solves and resolves many issues for gamers by gamers.

### 2. Related Art

The present invention provides for a gaming experience superior to current arcade and competitive gaming devices and equipment. The present invention is portable and more convenient, comfortable, versatile and adaptable to gaming for play in the home or away than present options. The portable gaming unit is for single or multiple-player use. The present portable arcade unit can house one or multiple liquid crystal display displays as well as other low-profile displays which completely integrate into the cabinet for gaming, storage and portability. The housing for the display(s) can fold (180-degrees) or extend (vertically) for maximum exposure for the user to utilize the full image displayed. The present invention further houses a storage tray for game controllers. This controller tray moves in a 90-degree angle to provide for simple transition from storage position to gaming position. The controller tray houses the gaming control modules which house the custom buttons and joystick configuration. The gaming control modules telescope away from the unit allowing the user(s) to remove the gaming controls for ease of use as well as for more comfort and convenience of positioning. The gaming control module can be customized for any user. The present invention further provides an accessible storage area or console cabinet to house any gaming console(s). Efforts in the area include the following:

Elite, U.S. Pat. No. 8,439,761, discloses a gaming cabinet with a gaming deck that slides out and rotates both up and down. The gaming deck telescopes out from the cabinet for additional spatial arrangement.

Inmusic, U.S. Design Pat. No. 656,551, discloses an ornamental design for an arcade-style cabinet for a tablet computer.

Quasimoto, US Patent Application 2004/0152,522, discloses a adapter system for taking a home gaming system and making it into a arcade-style system. It is adaptable to most commercial systems and can be connected to more than one system at a time.

Heathcote, U.S. Pat. No. 7,735,941, discloses gaming furniture that extends the gaming experience and expands it by adding accessories to enhance the gaming experience.

Riley, U.S. Pat. No. 8,749,959, discloses modular technology designed to provide for spatial arrangement of many components in a small footprint.

### SUMMARY

The disclosed invention is a portable compact gaming unit that supports the at-home gamer, the competitive gamer and the professional gamer. The versatility of present invention is in the foldable and retractable modules accompanying each unit making it extend to a full-sized arcade cabinet complete with display, controls and sounds and also making it collapse to a compact cabinet for storage and portability. In one embodiment, the unit has a single display housing which can retract into the cabinet, reducing the profile of the cabinet. The game controller tray is foldable to reduce the profile of the cabinet and unfolds for player use. In present embodiment, the game console compartment has double doors.

In another embodiment, the unit has dual displays in the display housing module folding into the unit, reducing the profile of the cabinet. The game console compartment is constructed with a single door and a custom plexiglass offering multiple ways to access the game console compartment. In all proposed embodiments, there is an auxiliary control hub where gaming console accessories can be added to the unit for player use. The auxiliary control hub has a custom plexiglass cover which allows for branding the unit and protecting USB ports for more interactive play. Present embodiment further comprises a custom console deck which can be customized for a specific gaming console.

In all embodiments of the unit, the power source is streamlined inside the game console compartment to source the components' power from a single source. All of the proposed embodiments of the unit include custom pieces for branding the units or customizing the badges on the unit for the user. The embodiments described herein and shown in the illustrations are all mobile via casters or other mobile utilities. The structure of each preferred and proposed embodiment includes a display housing module 108 secured to an arcade cabinet 130. Each embodiment has side panels 101 in parallel with each other as well as a front 126 and back 103 panel also in parallel with each other forming the base of the portable arcade cabinet. Additionally, all embodiments have a bottom panel 127 and a front reliance panel 102 comprising the arcade cabinet 130. All embodiments further include a cabinet door 116 or doors 116 opening to the gaming console compartment 129, multiple gaming control modules 107, a game controller tray 106 and an auxiliary controller hub 121. All embodiments also include a custom configuration of game control buttons 114 and a joystick 113 on the gaming control modules 107. All embodiments include a soundbar 112, stabilizing anchors 111, housing stands 110, fasteners 115 and support releases 123 for each of the display modules 108 to secure and stabilize each module for either “play” or “transport and storage” mode.

### BRIEF DESCRIPTION OF THE DRAWINGS

FIG. 1 illustrates the side view of one of the preferred embodiments of the portable arcade unit in “play” position in accordance with the disclosure provided herein;

FIG. 2 illustrates the front view of one of the preferred embodiments of the portable arcade unit in “play” position;

FIG. 3 illustrates the side view of another preferred embodiment of the portable arcade unit also in “play” position;

FIG. 4 illustrates the front view of the same preferred embodiment illustrated in FIG. 3 of the portable arcade unit in “play” position;

FIG. 5 illustrates a perspective of the top and front view of the fully collapsed compacted portable arcade unit in “storage and transport” position.

### DETAILED DESCRIPTION

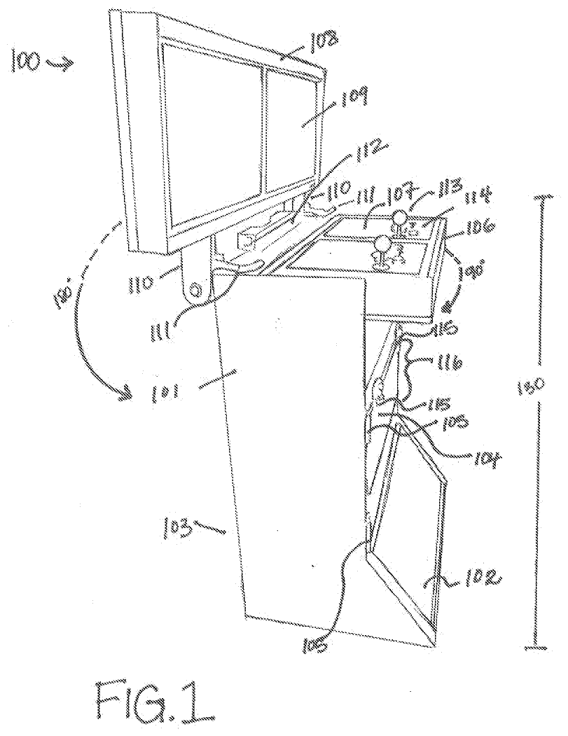

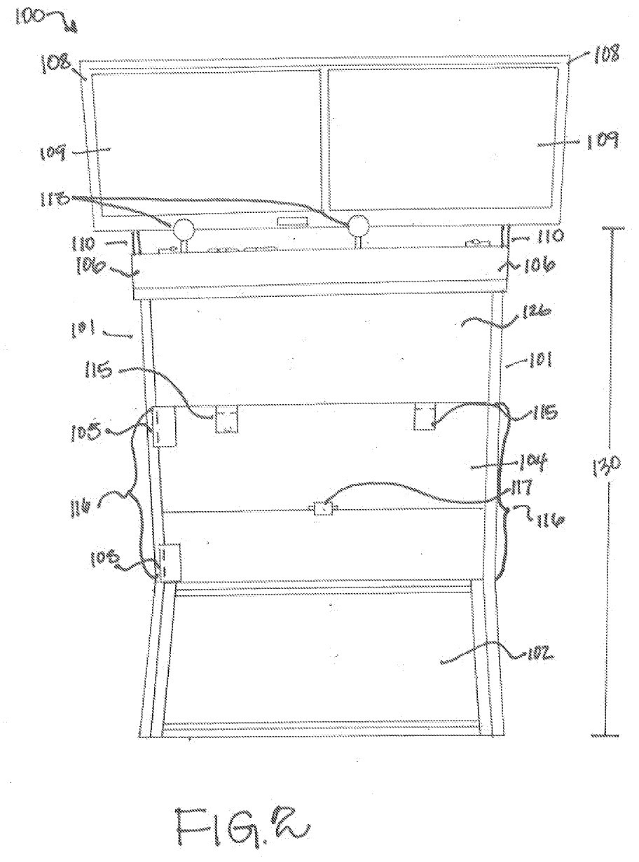

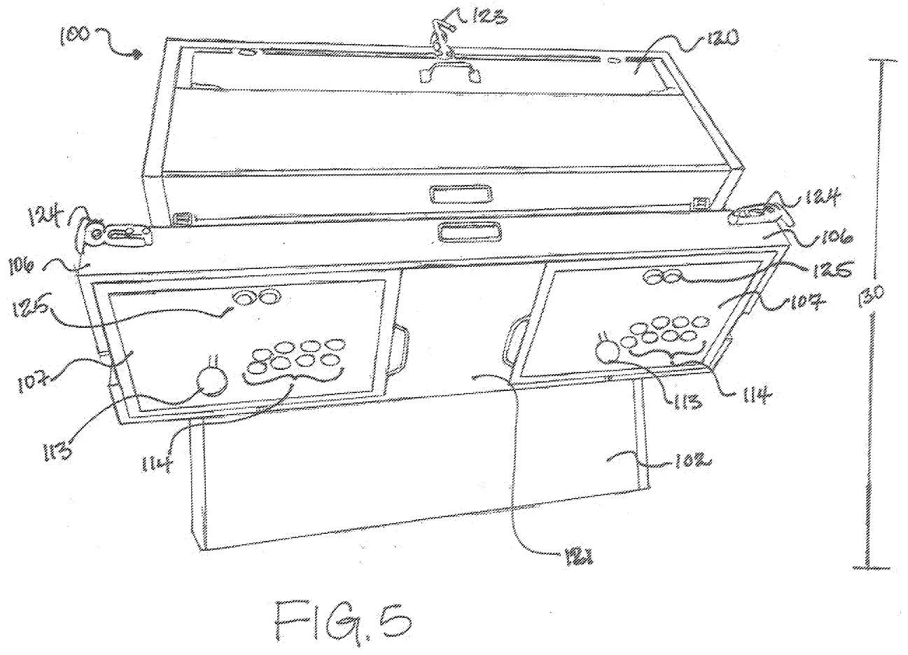

Referring now specifically to the figures, beginning with FIGS. 1 and 2 which illustrate a first preferred embodiment of the portable arcade unit 100. FIG. 1 is an illustration of the side view of the portable arcade unit 100 fully erect and ready to play in “play” position. The display housing module 108 is unfolded from the portable arcade unit 100 and extended up and is fastened securely atop the arcade cabinet 130 of the portable arcade unit 100 by the stabilizing anchors 111 which are connected to the display housing stands 110 that are connected to the back panel 103 and side panel 101 of the arcade cabinet 130 supporting the displays 109 and the display housing module 108. Further affixed atop the arcade cabinet 130 is the sound bar 112 centered between the stabilizing anchors 111 and the display housing stands 110 for the display housing module 108. The sound bar 112 is affixed to the arcade cabinet 130 such that the display housing module can fold 180-degrees vertically down and into the portable gaming unit 100 to the rear of the arcade cabinet 130 under the sound bar 112 . The game controller tray 106 is seen in its fully extended position which is 90 degrees from its “storage and transport” position which it is in when collapsed for travel and for storage as depicted in FIG. 5.; perpendicular to the arcade cabinet 130. illustrated positioned inside the game controller tray 106, are the gaming control modules 107 which house the game control buttons 114 and joystick 113. Further, illustrated in FIG. 1 is the side panel 101 which operates to supporting the portable arcade unit's 100 overall structure and arcade cabinet 130 which directly supports the display housing module 108, the game controller tray 106 with gaming control modules 107 along with the cabinet door 116 with cabinet door cover 104. The cabinet door cover 104 is attached to cabinet door 116 with cabinet door cover fasteners 115 while the cabinet door 116 is attached to the arcade cabinet 130 with cabinet door hinges 105. The cabinet door 116 is affixed to the arcade cabinet 130 above the front reliance panel 102. The front reliance panel 102 offers stability to the entire portable arcade unit 100 and is positioned in an anchoring position to the arcade cabinet 130.

FIG. 2 illustrates the front view of the portable arcade unit 100 in FIG. 1 fully erect in “play” position which further depicts the arcade cabinet 130, cabinet door cover 104 with a metal catch 117 which allows the cabinet door cover 104 to remain open if necessary after coming in contact with the magnetic surface on the front panel 126 of the arcade cabinet 130. The front panel 126 has a magnet that acts to secure the metal catch 117 when the cabinet door cover 104 is open.

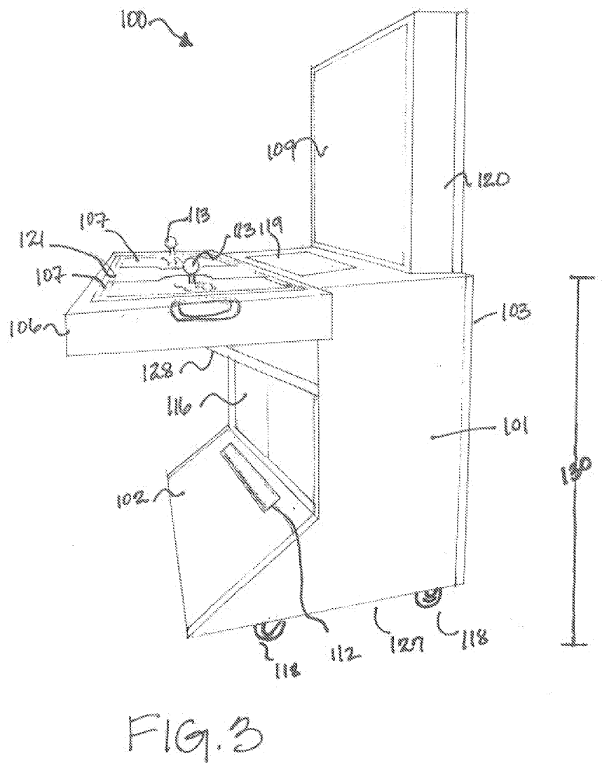

Illustrated in FIG. 3, a side view of another embodiment of the portable arcade unit 100 depicted fully erect in “play” position with the retractable display housing 120 and display 109 fully extended out from the arcade cabinet 130 for full exposure in “play” position for the user. The portable arcade unit's 100 arcade cabinet 130 also contains a console dock 119 for a specific gaming console and can be customized for any gaming console. Illustrated in this embodiment, the sound bar 112 is housed in the front reliance panel 102 and the casters 118 can be seen affixed to the bottom panel 127 of the arcade cabinet 130. The same orientation as in FIG. 1 of the side panels 101 and the front reliance panel 102 as connected to the bottom panel 127 and the back panel 103 is illustrated here in FIG. 3 for the arcade cabinet 130. Further illustrated is the game controller tray 106 in the fully erect “play” position from its “storage and transport” position with the gaming control modules 107 shown on either side of the auxiliary control hub cover 121b and auxiliary control hub 121 as seen between the joysticks 113 in this perspective. The tray support arm 128 is shown engaged to maintain the game control tray in the “play” position.

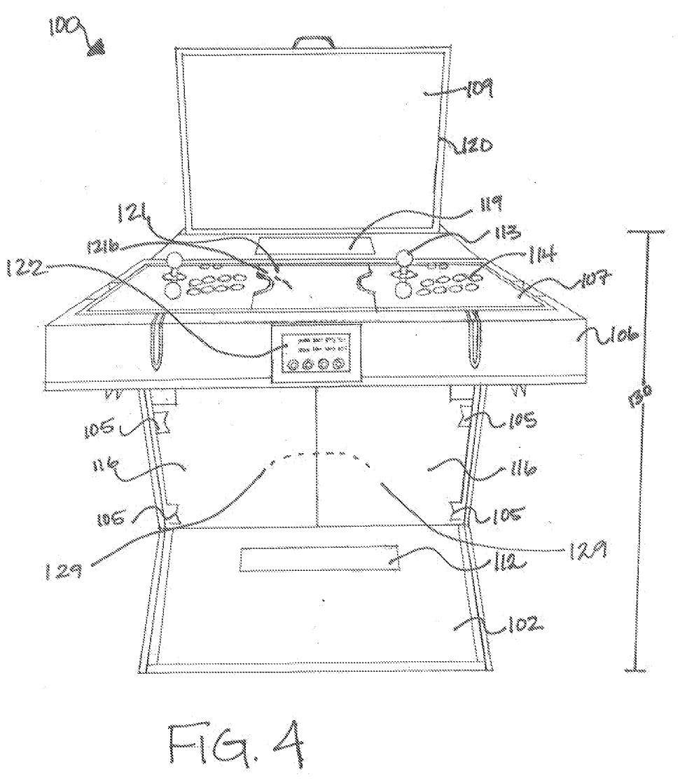

illustrated in FIG. 4 is a front view of the same embodiment in FIG. 3 of the portable arcade unit 100 in “play” position further depicting the auxiliary control hub cover 121b and the auxiliary control hub access 122 on the arcade cabinet 130 for connections to various gaming console controllers which can be used either instead of the gaming control modules 107 or concurrently. Further illustrated in FIG. 4, this embodiment has a slightly wider footprint than the preferred embodiment of the portable arcade unit 100 and the arcade cabinet 130 depicted in FIGS. 1 and 2 with a different gaming console compartment 129 configuration. The arcade cabinet 130 and cabinet doors 116 in FIG. 4 open in a 90-degree horizontal outward orientation perpendicular to the unit like French doors.

illustrated in FIG. 5 is the fully compacted and collapsed portable arcade unit 100 embodiment highlighting the arcade cabinet 130 as shown in FIGS. 3 and 4. The illustration is of the “storage and transport” position of the arcade cabinet 130 of the portable arcade unit 100. The retractable display housing is in “storage and transport” position which negotiates a slide into the arcade cabinet 130. The display support release 123 which secures the retractable display housing 120 in both “play” and “storage and transport” position is seen affixed to the back panel 103 of the arcade cabinet 130. The game controller tray 106 is folded down into “storage and transport” position exposing the game tray connectors 124 which secure the game controller tray 106 in “play” position. The gaming control modules 107 are fully disclosed by this view and in addition to the game buttons 114 and the joystick 113, the player selector buttons 125 are seen in this illustration. The front reliance panel 102 is shown stabilizing the portable arcade unit's 100 arcade cabinet 130 in its “storage and transport” position.

What is claimed is:

1. A portable arcade unit comprising:
a moveable display housing module;
an arcade cabinet;
a game controller tray;
a gaming control module;
a gaming console compartment.

2. A unit as in claim 1, wherein the unit can be comprised of a sturdy textile or a combination of sturdy textiles including wood, plastic, plexiglass, or glass.

3. A unit as in claim 1, wherein the moveable display housing module is affixed to the arcade cabinet to facilitate watching and playing games in “play” mode; can house singular or multiple displays which can be constructed to reduce the profile of the unit by any means including retracting or folding down and being secured in or to the arcade cabinet in “storage” or “transport” mode.

4. A unit as in claim 1, wherein the arcade cabinet acts as the anchor for the entire unit, specifically the moveable display housing module while also housing the game controller tray, gaming console compartment, arcade cabinet doors for access to the gaming console compartment, a sound bar for sound augmentation in “play” mode and panels outlining the design and stabilization of the unit of claim 1 for either: “play”, “storage” or “transport” mode.

5. A unit in claim 1, wherein the game controller tray is affixed to the arcade cabinet and extends and scopes from the arcade cabinet supported by a tray support arm affixed to the arcade cabinet providing the housing for gaming control modules and an auxiliary control hub. The gaming control modules can further scope from the game controller tray and the unit itself.

6. A unit in claim 1, wherein the gaming control module is affixed to the arcade cabinet by cable and sits inside the game controller tray and is customizable and comprises a joystick and customizable game control buttons that can be configured in any requested design.

7. A unit in claim 1, wherein the gaming console compartment is configured by panels outlining and structuring the arcade cabinet to allow for commercial or home-grown gaming systems to reside for connectivity to displays when the arcade cabinet is positioned in “play” mode.

8. A gaming console compartment further comprising a door or set of doors or closures which secure the gaming console in the gaming console compartment and also provide access to the compartment. Said doors can have a plurality of different connecting orientations to the arcade cabinet itself such as being secured by vertical hinges on one end and spanning the width of the arcade cabinet providing access to the gaming console compartment by a single directional fulcrum and access point or by dual closures or side-by-side doors which provide access to the gaming console compartment by providing access to the entire compartment when both are opened on opposite but vertical fulcrums as with “french doors.”

9. The arcade cabinet in claim 4, further comprising front, side and back panels and a front reliance panel to erect a stable arcade cabinet able to support displays and their respective display housing modules, controller trays and controllers, along with different gaming consoles singularly or in multiples. The arcade cabinet further comprises a transport means, as in casters or wheels, affixed to the bottom of the arcade cabinet to facilitate its transportability which can be locked when the cabinet is maintaining a stationary position. The arcade cabinet further comprises display housing module support and release mechanisms for “play” or “transport and storage” mode.

10. An auxiliary control hub as in claim 5, further comprising an auxiliary control hub cover for customizing the arcade cabinet and protecting the auxiliary control hub and an auxiliary gaming console controller access promoting interactive competitive gaming.
